(19) United States
(12) Patent Application Publication
(10) Pub. No.: US 2010/0279080 A1
(43) Pub. Date: Nov. 4, 2010

(54) PRINTING INK SET

(76) Inventors: Tudor Morgan, Kent (GB); Angelique Catherine Joyce Runacre, Kent (GB)

Correspondence Address: BUCKLEY, MASCHOFF & TALWALKAR LLC, 50 LOCUST AVENUE, NEW CANAAN, CT, 06840, US

(21) Appl. No.: 12/600,383

(22) PCT Filed: May 13, 2008
(86) PCT No.: PCT/GB08/01656

§ 371 Date: Mar. 24, 2010

(30) Foreign Application Priority Data
May 14, 2007 (GB) 0709252.1
Jul. 6, 2007 (GB) 0713204.6
May 13, 2008 (GB) PCT/GB2008/001656

(51) Int. Cl. B41J 2/175; C09D 11/10; B32B 27/04

(52) U.S. Cl. 428/195.1; 347/102; 522/104; 522/173; 522/181; 522/74; 522/75; 522/81

(57) ABSTRACT

This invention relates to a printing ink set. The ink-jet ink set comprises a plurality of ink-jet inks, each ink being substantially free of water and volatile organic solvents, having a viscosity of 100 mPas or less at 25° C., and comprising at least one radiation-curable monomer, a photoinitiator, and a colorant, wherein the set includes a cyan ink, a magenta ink, a yellow ink, a black ink, and one or more of an orange ink, a green ink and a violet ink. The ink set may also include light CYMK inks. An eight ink set comprising cyan, magenta, yellow, black, orange, green, violet and light magenta inks is also disclosed.

This invention relates to a printing ink set and in particular to a printing ink set having a wider colour gamut than existing ink sets.

In colour reproduction, a gamut is a subset of colours which, when printed together, represent a given colour space. It is particularly desirable in colour reproduction to be able to represent, to the greatest degree possible, the entire visible colour space.

Gamuts are commonly represented as areas in the CIE 1931 (Commission Internationale de l'Eclairage) chromaticity diagram where specific colours are assigned L*a*b* values according to their position on the diagram.

In ink jet printing, minute droplets of black, white or coloured ink are ejected in a controlled manner from one or more reservoirs or printing heads through narrow nozzles on to a substrate which is moving relative to the reservoirs. The ejected ink forms an image on the substrate. For high-speed printing, the inks must flow rapidly from the printing heads, and, to ensure that this happens, they must have in use a low viscosity, typically below 100 mPas at 25° C. although in most applications the viscosity should be below 50 mPas, and often below 25 mPas. Typically, when ejected through the nozzles, the ink has a viscosity of less than 25 mPas, preferably 5-15 mPas and ideally 10.5 mPas at the jetting temperature which is often elevated to about 40° C. (the ink might have a much higher viscosity at ambient temperature). The inks must also be resistant to drying or crusting in the reservoirs or nozzles. For these reasons, ink-jet inks for application at or near ambient temperatures are commonly formulated to contain a large proportion of a mobile liquid vehicle or solvent. In one common type of ink jet ink this liquid is water—see for example the paper by Henry R. Kang in the Journal of Imaging Science, 35(3), pp. 179-188 (1991). In those systems, great effort must be made to ensure the inks do not dry in the head due to water evaporation. In another common type the liquid is a low-boiling solvent or mixture of solvents—see, for example, EP 0 314 403 and EP 0 424 714.

Another type of ink jet ink contains unsaturated organic compounds, termed monomers, which polymerise by irradiation, commonly with ultraviolet light, in the presence of a photoinitiator. This type of ink has the advantage that it is not necessary to evaporate the liquid phase to dry the print; instead the print is exposed to radiation to cure or harden it, a process which is more rapid than evaporation of solvent at moderate temperatures. In such ink-jet inks it is necessary to use monomers possessing a low viscosity.

Ink jet ink sets typically use the CMYK colour space, i.e. the ink jet ink set contains cyan, magenta, yellow and black inks. This ink-jet ink set has also been expanded to the hexachrome set which, in addition to CMYK, also includes orange and green inks. For example, JP 2001-354886 discloses a water-based ink jet ink set comprising green and red inks in addition to the cyan, magenta, yellow and black inks. As a further example, EP 1 746 138 discloses an ink jet ink set comprising magenta and light magenta inks in addition to the cyan, magenta, yellow and black inks.

However, even these expanded ink sets provide a limited representation of the visible colour space. Nevertheless, further development of ink sets is limited by the considerable technical details associated with formulating compatible inks and the necessity of finding appropriate colour combinations. The number of colours should also be kept to a minimum as a separate printing head is required for each colour.

There is therefore a requirement in the art for ink-jet ink sets which achieve a better representation of the visible colour space without compromising the printing properties of the inks.

Accordingly, the present invention provides an ink-jet ink set comprising a plurality of ink-jet inks, each ink being substantially free of water and volatile organic solvents, having a viscosity of 100 mPas or less at 25° C., and comprising at least one radiation-curable monomer, a photoinitiator, and a colorant, wherein the set includes a cyan ink, a magenta ink, a yellow ink, a black ink, and one or more of an orange ink, a green ink and a violet ink.

In another embodiment, the ink set comprises a cyan ink, a magenta ink, a yellow ink, a black ink, and at least two of an orange ink, a green ink, and a violet ink.

In another embodiment, the ink set comprises a cyan ink, a magenta ink, a yellow ink, a black ink, an orange ink, a green ink and a violet ink.

In another embodiment, the ink set further comprising one or more of a light cyan ink, a light magenta ink, a light yellow ink a light black ink and a white ink.

In another embodiment, the ink set comprises a cyan ink, a magenta ink, a yellow ink, a black ink, an orange ink, a green ink, a violet ink and a light magenta ink.

In another embodiment, the ink set comprises a cyan ink, a magenta ink, a yellow ink, a black ink, an orange ink, a violet ink and one or more of a green ink, a light magenta ink and a white ink.

In another embodiment, the ink set comprises a cyan ink, a magenta ink, a yellow ink, a black ink, an orange ink, a violet ink, a light magenta ink and a white ink.

In a particularly preferred embodiment, the set consists of these eight inks and no others.

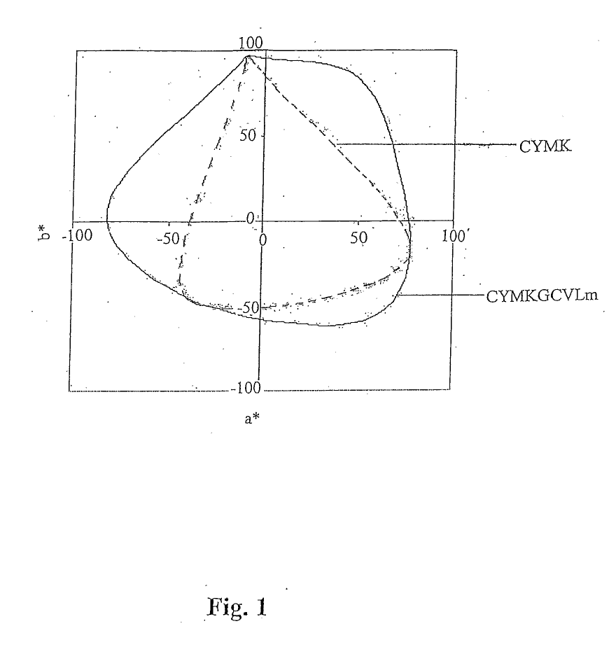

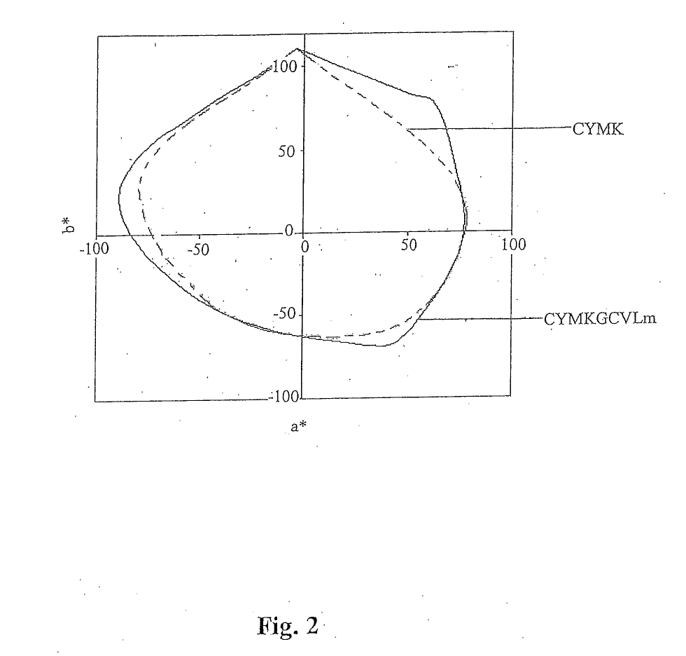

The present invention will now be described with reference to the accompanying drawings, in which FIGS. 1 and 2 show graphs representing the colour gamut of the ink-jet ink set of the present invention compared to the standard CMYK set.

Inks may be formulated as solvent-based inks or curable inks. The solvent-based inks may contain water or volatile organic solvents. Such inks are well known in the art; see EP 0 314 403 and EP 0 424 714 for details of their formulations. The ink-jet inks of the present invention dry primarily by curing, i.e. by the polymerisation of the monomers present, as discussed hereinabove, and hence is a curable ink. Such inks do not, therefore, require the presence of water or a volatile organic solvent to effect drying of the ink, although the presence of such components may be tolerated. Therefore, the ink-jet inks of the present invention are preferably substantially free of water and volatile organic solvents. This avoids the drawbacks of solvent-based inks as discussed hereinabove.

However, curable inks provide an even greater challenge for the ink formulator because curable inks require a greater weight of ink to be put down on the substrate to achieve the same level of detail and colour intensity as solvent-based inks which has a tendency to affect the curability and film properties.

The inks of the present invention preferably include at least one (meth)acrylate monomer, at least one photoinitiator and at least one at least one colouring agent. The at least one (meth)acrylate monomer is preferably selected from a monofunctional monomer, a multifunctional monomer and combinations thereof.

Examples of the multifunctional acrylate monomers which may be included in the ink-jet inks include hexanediol diacrylate, trimethylolpropane triacrylate, pentaerythritol triacrylate, polyethyleneglycol diacrylate, for example, tetraethyleneglycol diacrylate), dipropyleneglycol diacrylate, tri(propylene glycol) triacrylate, neopentylglycol diacrylate, bis(pentaerythritol) hexaacrylate, and the acrylate esters of ethoxylated or propoxylated glycols and polyols, for example, propoxylated neopentyl glycol diacrylate, ethoxylated trimethylolpropane triacrylate, and mixtures thereof. Particularly preferred are difunctional acrylates. Also preferred are those with a molecular weight greater than 200. A preferred combination of monomers is hexanediol diacrylate, dipropyleneglycol diacrylate and propoxylated neopentyl glycol diacrylate.

In addition, suitable multifunctional acrylate monomers include esters of methacrylic acid (i.e. methacrylates), such as hexanediol dimethacrylate, trimethylolpropane trimethacrylate, triethyleneglycol dimethacrylate, diethyleneglycol dimethacrylate, ethyleneglycol dimethacrylate, 1,4-butanediol dimethacrylate. Mixtures of (meth)acrylates may also be used.

Multifunctional (meth)acrylate monomers may be included at 0-90% by weight, preferably 5-85% by weight, more preferably 40-80%, most preferably 50-70% by weight, based on the total weight of the ink.

The monofunctional (meth)acrylate monomers are also well known in the art and are preferably the esters of acrylic acid. Preferred examples include phenoxyethyl acrylate, cyclic TMP formal acrylate, isobornyl acrylate, tetrahydrofurfuryl acrylate, 2-(2-ethoxyethoxy)ethyl acrylate, octadecyl acrylate, tridecyl acrylate, isodecyl acrylate and lauryl acrylate.

Monofunctional (meth)acrylate monomers may be included at 1-90% by weight, preferably 3-80% by weight, more preferably 5-30% by weight, most preferably 10-20% by weight, based on the total weight of the ink.

(Meth)acrylate is intended herein to have its standard meaning, i.e. acrylate and/or methacrylate. Mono and multifunctional are also intended to have their standard meanings, i.e. one and two or more groups, respectively, which take part in the polymerisation reaction on curing.

The inks of the present invention may also contain α,β-unsaturated ether monomers, such as vinyl ethers. These monomers are known in the art and may be used to reduce the viscosity of the ink formulation. Typical vinyl ether monomers which may be used in the inks of the present invention are triethylene glycol divinyl ether, diethylene glycol divinyl ether, 1,4-cyclohexanedimethanol divinyl ether and ethylene glycol monovinyl ether. Mixtures of vinyl ether monomers may be used.

The vinyl ether monomer is preferably 1-20% by weight, more preferably 7-15% by weight, based on the total weight of the ink. In a preferred embodiment, the ratio of acrylate monomer to vinyl ether monomer is from 4:1 and 15:1. See WO 02/061001 for further details of formulations containing α,β-unsaturated ether monomers in combination with acrylate monomers.

N-Vinyl amides and N-(meth)acryloyl amines may also be used in the inks. These monomers are well-known in the art. Preferred examples of N-vinyl amides are N-vinyl caprolactam and N-vinyl pyrrolidone; and of N-(meth)acryloyl amines, N-acryloylmorpholine.

N-Vinyl amides and/or N-acryloyl amines may be included at 3-50% by weight, preferably 5-30% by weight, more preferably 10-20% by weight, based on the total weight of the ink.

It is possible to modify further the film properties of the ink-jet inks by inclusion of oligomers or inert resins, such as thermoplastic acrylics. However, it should be noted that in the case of oligomers and multifunctional monomers the flexibility may be adversely affected and also that some adjustments to stoichiometry may be required to retain optimum cure speed. Said oligomers have weight-average molecular weight from 500 to 8,000, preferably from 1,000 to 7,000 and most preferably from 2,000 to 6,000.

Oligomers may be included at 0-30% by weight, preferably 2-20% by weight and more preferably 4-15% by weight, based on the total weight of the ink.

In addition to the monomers described above, the compositions include a photoinitiator, which, under irradiation by, for example, ultraviolet light, initiates the polymerisation of the monomers. Preferred are photoinitiators which produce free radicals on irradiation (free radical photoinitiators) such as, for example, benzophenone, 1-hydroxycyclohexyl phenyl ketone, 2-benzyl-2-dimethylamino-(4-morpholinophenyl)butan-1-one, benzil dimethylketal, bis(2,6-dimethylbenzoyl)-2,4,4-trimethylpentylphosphine oxide or mixtures thereof. Such photoinitiators are known and commercially available such as, for example, under the trade names Irgacure, Darocur (from Ciba) and Lucerin (from BASF).

Preferably the photoinitiator is present from 1 to 20% by weight, preferably from 4 to 10% by weight, of the ink.

The ink-jet ink of the present invention also includes a colouring agent, which may be either dissolved or dispersed in the liquid medium of the ink. Preferably the colouring agent is a dispersible pigment. The colouring agents are commercially available, for example under the trade-names Paliotol (available from BASF plc), Cinquasia, Irgalite (both available from Ciba Speciality Chemicals) and Hostaperm (available from Clariant UK).

The cyan and light cyan inks have a* value from −60 to −10 and b* value from −70 to −20, preferably a* value from −55 to −15 and b* value from −65 to −25, more preferably a* value from −50 to −20 and b* value from −60 to −30, most preferably a* value from −45 to −25 and b* value from −55 to −35. The cyan ink has L* value from 35 to 69, preferably 40 to 67, more preferably 45 to 65. The light cyan ink has L* value from 71 to 105, preferably 73 to 100, more preferably 75 to 95. The cyan and light cyan inks preferably contain the dispersible pigment blue 15:3, more preferably IRGALITE BLUE GLVO. Other pigments that could be used include pigment blue 15:1, pigment blue 15:2, pigment blue 15:6 and combinations thereof.

The magenta and light magenta inks have a* value from 55 to 105 and b* value from −40 to 10, preferably a* value from 60 to 100 and b* value from −35 to 5, more preferably a* value from 65 to 95 and b* value from −30 to 0, most preferably a* value from 70 to 90 and b* value from −25 to −5. The magenta ink has L* value from 30 to 64, preferably 35 to 62, more preferably 40 to 60. The light magenta ink has L* value from 66 to 100, preferably 68 to 95, more preferably 70 to 90. The magenta and light magenta inks preferably contain the dispersible pigment red 202 and/or pigment violet 19, more preferably CINQUASIA MAGENTA RT-355 D. Other pigments that could be used include pigment red 9, pigment red 184, pigment violet 22, pigment violet 23, pigment violet 122 and combinations thereof.

The yellow and light yellow inks have a* value from −40 to 10 and b* value from 70 to 120, preferably a* value from −35 to 5 and b* value from 75 to 115, more preferably a* value from −30 to 0 and b* value from 80 to 110, most preferably a* value from −25 to −5 and b* value from 85 to 105. The yellow ink has L* value from 70 to 104, preferably 75 to 102, more preferably 80 to 100. The light yellow ink has L* value from 106 to 140, preferably 108 to 135, more preferably 110 to 130. The yellow and light yellow inks preferably contain the dispersible pigment yellow 120, more preferably NOVOPERM YELLOW H2G. Other pigments that could be used include pigment yellow 13, pigment yellow 83, pigment yellow 138, pigment yellow 150, pigment yellow 151, pigment yellow 155, pigment yellow 180, pigment yellow 194 and combinations thereof.

The black and light black inks have a* value from −25 to 25 and b* value from −20 to 30, preferably a* value from −20 to 20 and b* value from −15 to 25, more preferably a* value from −15 to 15 and b* value from −10 to 20, most preferably a* value from −10 to 10 and b* value from −5 to 15. The black ink has L* value from 6 to 30, preferably 8 to 25, more preferably 10 to 20. The light black ink has L* value from 35 to 75, preferably 40 to 70, more preferably 45 to 65. The black and light black inks preferably contain the dispersible pigment black 7, more preferably SPECIAL BLACK 250. Other pigments that could be used include carbon black, pigment black 6, pigment black 8 and combinations thereof.

Other colouring agents may also be used. The light versions of these four inks will always contain less pigment than the base ink in order to provide the lighter colour. Typically the light ink will contain 2-50%, preferably 4-40%, more preferably 6-30% by weight of the amount of pigment compared to the amount of pigment present in the base ink.

The orange ink has a* value from 25 to 75 and b* value from 55 to 105, preferably a* value from 30 to 70 and b* value from 60 to 100, more preferably a* value from 35 to 65 and b* value from 65 to 95, most preferably a* value from 40 to 60 and b* value from 70 to 90. The orange ink has L* value from 50 to 90, preferably 55 to 85, more preferably 60 to 80. The orange ink preferably contains the dispersible pigment orange 36, more preferably Kenalake Orange HPRLO.

The green ink has a* value from −105 to −55 and b* value from −15 to 35, preferably a* value from −100 to −60 and b* value from −10 to 30, more preferably a* value from −95 to −65 and b* value from −5 to 25, most preferably a* value from −90 to −70 and b* value from 0 to 20. The green ink has L* value from 40 to 80, preferably 45 to 75, more preferably 50 to 70. The green ink preferably contains the dispersible pigment green 7, more preferably HEUCO GREEN 600703K.

The violet ink has a* value from 35 to 85 and b* value from −90 to −40, preferably a* value from 40 to 80 and b* value from −85 to −45, more preferably a* value from 45 to 75 and b* value from −80 to −50, most preferably a* value from 50 to 70 and b* value from −75 to −55. The green ink has L* value from 10 to 50, preferably 15 to 45, more preferably 20 to 40. The violet ink preferably contains the dispersible pigment violet 23, more preferably Hostaperm Violet RL-NF. Other pigments that could be used include pigment violet 19, pigment violet 22, pigment violet 23, pigment violet 122 and combinations thereof.

The white ink has a* value from −25 to 25 and b* value from −20 to 30, preferably a* value from −20 to 20 and b* value from −15 to 25, more preferably a* value from −15 to 15 and b* value from −10 to 20, most preferably a* value from −10 to 10 and b* value from −5 to 15. The black ink has L* value from 81 to 99, preferably 83 to 97, more preferably 85 to 95. The green ink preferably contains the dispersible pigment white 6, more preferably Tipaque CR-60-2.

The above-mentioned values are summarised in the following table:

| | | |
|---|---|---|
| L | a* | b* |

| | | | | | | |
|---|---|---|---|---|---|---|
| C | 35 | 69 | −60 | −10 | −70 | −20 |
| | 40 | 67 | −55 | −15 | −65 | −25 |
| | 45 | 65 | −50 | −20 | −60 | −30 |
| | | | −45 | −25 | −55 | −35 |
| M | 30 | 64 | 55 | 105 | −40 | 10 |
| | 35 | 62 | 60 | 100 | −35 | 5 |
| | 40 | 60 | 65 | 95 | −30 | 0 |
| | | | 70 | 90 | −25 | −5 |
| Y | 70 | 104 | −40 | 10 | 70 | 120 |
| | 75 | 102 | −35 | 5 | 75 | 115 |
| | 80 | 100 | −30 | 0 | 80 | 110 |
| | | | −25 | −5 | 85 | 105 |
| K | 6 | 30 | −25 | 25 | −20 | 30 |
| | 8 | 25 | −20 | 20 | −15 | 25 |
| | 10 | 20 | −15 | 15 | −10 | 20 |
| | | | −10 | 10 | −5 | 15 |
| W | 81 | 99 | −25 | 25 | −20 | 30 |
| | 83 | 97 | −20 | 20 | −15 | 25 |
| | 85 | 95 | −15 | 15 | −10 | 20 |
| | | | −10 | 10 | −5 | 15 |
| O | 50 | 90 | 25 | 75 | 55 | 105 |
| | 55 | 85 | 30 | 70 | 60 | 100 |
| | 60 | 80 | 35 | 65 | 65 | 95 |
| | | | 40 | 60 | 70 | 90 |
| G | 40 | 80 | −105 | −55 | −15 | 35 |
| | 45 | 75 | −100 | −60 | −10 | 30 |
| | 50 | 70 | −95 | −65 | −5 | 25 |
| | | | −90 | −70 | 0 | 20 |
| V | 10 | 50 | 35 | 85 | −90 | −40 |
| | 15 | 45 | 40 | 80 | −85 | −45 |
| | 20 | 40 | 45 | 75 | −80 | −50 |
| | | | 50 | 70 | −75 | −55 |
| LC | 71 | 105 | −60 | −10 | −70 | −20 |
| | 73 | 100 | −55 | −15 | −65 | −25 |
| | 75 | 95 | −50 | −20 | −60 | −30 |
| | | | −45 | −25 | −55 | −35 |
| LM | 66 | 100 | 55 | 105 | −40 | 10 |
| | 68 | 95 | 60 | 100 | −35 | 5 |
| | 70 | 90 | 65 | 95 | −30 | 0 |
| | | | 70 | 90 | −25 | −5 |
| LY | 106 | 140 | −40 | 10 | 70 | 120 |
| | 108 | 135 | −35 | 5 | 75 | 115 |
| | 110 | 130 | −30 | 0 | 80 | 110 |
| | | | −25 | −5 | 85 | 105 |
| LK | 35 | 75 | −25 | 25 | −20 | 30 |
| | 40 | 70 | −20 | 20 | −15 | 25 |
| | 45 | 65 | −15 | 15 | −10 | 20 |
| | | | −10 | 10 | −5 | 15 |

In a preferred embodiment, the ink jet ink set of the present invention contains the orange, green and violet inks having the afore-mentioned pigments. This combination of pigments has been found to provide a particularly broad colour gamut, especially when combined with the CMYK and optionally the light inks mentioned above. However, other colouring agents may also be used.

The total proportion of pigment present is preferably from 0.5 to 15% by weight, more preferably from 0.5 to 5% by weight, based on the total weight of the ink, with the proviso that, as mentioned above, the light magenta will always contain less colouring agent than the magenta ink.

Although the ink of the present invention cures by a free radical mechanism, the ink of the present invention may also be a so-called “hybrid” ink which cures by a radical and cationic mechanism. The ink jet ink of the present invention, in one embodiment, therefore further comprises at least one cationically curable monomer, such as a vinyl ether, and at least one cationic photoinitiator, such as an iodonium or sulfonium salt, e.g. diphenyliodonium fluoride and triphenylsulfonium hexaflurophosphate. Suitable cationic photoinitiators include the Union Carbide UVI-69-series, Deuteron UV 1240 and IJY2257, Ciba Irgacure 250 and CGI 552, IGM-C440, Rhodia 2047 and UV9380c.

Other components of types known in the art may be present in the ink to improve the properties or performance. These components may be, for example, surfactants, defoamers, dispersants, synergists for the photoinitiator, stabilisers against deterioration by heat or light, reodorants, flow or slip aids, biocides and identifying tracers.

The present invention also provides a method of ink jet printing using the above-described ink set and a substrate having the cured inks thereon. The colour set of the present invention is particularly suited to piezoelectric drop-on-demand ink jet printing. Suitable substrates include styrene, PolyCarb (a polycarbonate), BannerPVC (a PVC) and VIVAK (a polyethylene terephthalate glycol modified). The inks of the present invention are preferably cured by ultraviolet irradiation and are suitable for application by ink-jet printing. The present invention further provides a set of ink-jet ink cartridges, each cartridge containing one of the colours of the ink jet inks as defined herein. The cartridges comprise an ink container and an ink delivery port which is suitable for connection with an ink jet printer.

The ink jet inks exhibit a desirable low viscosity (less than 100 mPas, preferably less than 50 mPas and most preferably 25 mPas or less at 25° C.). Viscosity may be measured using a Brookfield viscometer fitted with a thermostatically controlled cup and spindle arrangement, such as model LDV1+ with the ULA spindle and cup arrangement at 25° C. or a DVI low-viscosity viscometer running at 20 rpm at 25° C. with spindle 00.

The inks of the invention may be prepared by known methods such as, for example, stirring with a high-speed water-cooled stirrer, or milling on a horizontal bead-mill.

### EXAMPLES

The invention will now be described, by way of example, with reference to the following example (parts given are by weight).

### Example 1

Ink-jet ink formulations having the following compositions were prepared by mixing the components in the given amounts (percentages are by weight and are based on the total weight of the ink).

### Orange:

| Component | % |
|---|---|
| dPGDA | 24.10 |
| HDDA | 29.99 |
| Firstcure ST1 | 0.43 |
| Ebecryl 657 | 8.00 |
| DVE-3 | 11.00 |
| Irgacure 184 | 2.00 |
| Lucerin TPO | 8.50 |
| Benzophenone | 3.00 |
| Byk 307 | 0.10 |
| Solsperse 22000 | 0.14 |
| Solsperse 32000 | 1.37 |
| nPGDA | 7.47 |
| Kenalake Orange HPRLO | 3.90 |

### Violet:

| Component | % |
|---|---|
| dPGDA | 28.37 |
| HDDA | 30.00 |
| Firstcure ST1 | 0.86 |
| Ebecryl 657 | 12.69 |
| DVE-3 | 9.43 |
| Irgacure 184 | 1.88 |
| Lucerin TPO | 8.01 |
| Benzophenone | 2.82 |
| Byk 307 | 0.10 |
| Solsperse 32000 | 0.47 |
| nPGDA | 4.19 |
| Hostaperm Violet RL-NF | 1.18 |

### Green:

| Component | % |
|---|---|
| dPGDA | 23.88 |
| HDDA | 29.99 |
| Firstcure ST1 | 1.18 |
| Ebecryl 657 | 8.70 |
| DVE-3 | 10.40 |
| Irgacure 184 | 3.00 |
| Lucerin TPO | 8.50 |
| Benzophenone | 2.00 |
| Byk 307 | 0.10 |
| Solsperse 5000 | 0.07 |
| Solsperse 32000 | 2.02 |
| nPGDA | 6.37 |
| HEUCO GREEN 600703K | 3.79 |

### Black:

| Component | % |
|---|---|
| TEGORAD 2100 | 0.48 |
| SOLSPERSE 5000(A83061) | 0.079 |
| SOLSPERSE 32000 (A83060) | 0.79 |
| FIRSTCURE ST - 1 | 0.35 |
| IRGACURE 184 | 1.92 |
| LUCERIN TPO | 8.17 |
| BENZOPHENONE (C75160) | 2.88 |
| HDDA | 30.00 |
| RAPI-CURE DVE3 | 9.62 |
| EM222 DPGDA | 30.46 |
| SR9003 (NPGPODA) | 2.248 |
| SPECIAL BLACK 250 | 2.116 |
| EBECRYL 230 | 2.18 |
| SARTOMER CN964 A85 | 8.70 |

### Magenta:

| Component | % |
|---|---|
| BYK 307 | 0.05 |
| DISPERBYK 168 | 5.46 |
| FIRSTCURE ST - 1 | 0.30 |
| IRGACURE 184 | 3.00 |
| LUCERIN TPO | 8.50 |
| BENZOPHENONE (C75160) | 4.00 |
| HDDA | 30.00 |
| RAPI-CURE DVE3 | 11.64 |
| EM222 DPGDA | 24.65 |
| CINQUASIA MAGENTA RT-355 D | 3.90 |
| EBECRYL 230 | 1.70 |
| SARTOMER CN964 A85 | 6.80 |

### Cyan:

| Component | % |
|---|---|
| BYK 307 | 0.10 |
| SOLSPERSE 32000 (A83060) | 0.453 |
| FIRSTCURE ST - 1 | 0.845 |
| IRGACURE 184 | 1.88 |
| LUCERIN TPO | 8.01 |
| BENZOPHENONE (C75160) | 2.82 |
| HDDA | 30.00 |
| RAPI-CURE DVE3 | 9.43 |
| EM222 DPGDA | 31.00 |
| SR9003 (NPGPODA) | 2.673 |
| IRGALITE BLUE GLVO | 1.359 |
| EBECRYL 230 | 2.29 |
| SARTOMER CN964 A85 | 9.14 |

### Yellow:

| Component | % |
|---|---|
| BYK 307 | 0.10 |
| DISPERBYK 168 | 4.368 |
| FIRSTCURE ST - 1 | 0.30 |
| IRGACURE 184 | 2.48 |
| LUCERIN TPO | 7.98 |
| BENZOPHENONE (C75160) | 2.81 |
| HDDA | 30.00 |
| RAPI-CURE DVE3 | 12.30 |
| EM222 DPGDA | 26.82 |
| NOVOPERM YELLOW H2G | 3.12 |
| EBECRYL 657 (R49450) | 9.72 |

### Light Magenta:

| Component | % |
|---|---|
| BYK 307 | 0.05 |
| DISPERBYK 168 | 1.365 |
| FIRSTCURE ST - 1 | 0.30 |
| IRGACURE 184 | 3.00 |
| LUCERIN TPO | 8.50 |
| BENZOPHENONE (C75160) | 4.00 |
| RAPI-CURE DVE3 | 9.91 |
| EM222 DPGDA | 64.40 |
| CINQUASIA MAGENTA RT-355 D | 0.975 |
| EBECRYL 657 (R49450) | 7.50 |

Other suitable inks include:

### Light Cyan:

| Component | % |
|---|---|
| BYK 307 | 0.100 |
| SOLSPERSE 32000 | 0.113 |
| FIRSTCURE ST - 1 | 0.811 |
| IRGACURE 184 | 1.880 |
| LUCERIN TPO | 8.010 |
| BENZOPHENONE | 2.820 |
| HDDA | 30.000 |
| RAPI-CURE DVE3 | 9.430 |
| EM222 DPGDA | 33.580 |
| SR9003 (NPGPODA) | 0.667 |
| IRGALITEBLUEGLVO | 0.339 |
| CRAYNOR CN964 A85 | 9.800 |
| EBECRYL 230 | 2.450 |

### White:

| Component | % |
|---|---|
| SOLSPERSE 41000 | 1.059 |
| BYK 307 | 0.100 |
| FIRSTCURE ST - 1 | 0.600 |
| IRGACURE 184 | 3.000 |
| LUCERIN TPO | 8.500 |
| HDDA | 26.550 |
| RAPI-CURE DVE | 38.000 |
| EM222 DPGDA | 17.050 |
| SR9003 (NPGPODA) | 13.641 |
| KRONOS 2300 | 15.000 |
| CRAYNOR CN964 A85 | 5.200 |
| EBECRYL 230 | 1.300 |

### Example 2

The inks prepared in Example 1 were tested for various properties.

The cure speed and adhesion of the green, orange and violet inks were evaluated by comparison with other inks in the set, which were known to show appropriate cure speed and adhesion. Stability and surface tension were also found to be similar to existing inks within the ink set. The following tests were performed.

### Wet Ink Sample Test Parameters:

Viscosity was measured using a Brookfield DV1 low viscosity viscometer running at 20 rpm at 25° C. with spindle OO.

Particle size was measured using a Malvern Mastersizer S laser particle size diffraction unit. The figure quoted is where 90% of the particles in the sample by volume were less than this figure. Microscope images were also used to check particle size, and bulk particles were found to be less than one micron, and deflocculated.

### Print Sample Test Parameters:

Inks were drawn down onto a 220 micron gloss PVC substrate using an automatic RK coating machine and a 12 micron wire wound K bar (K2) applicator, at speed 6. The films were cured using a Svecia UV drier fitted with two 80 W/cm lamps set to half power.

Colour was measured using a Gretag Macbeth Spectro Eye spectrophotometer at d65 illuminant and 2 degrees observer and is quoted in terms of the L*a*b* values according to CIE 1931.

Cure speed was checked by curing alongside existing inks from the BX ink range, ensuring that the cured film was not tacky and that scratch adhesion and cross hatch adhesion were present.

Cure speed and adhesion were assessed by printing images on the Inca Spyder 320 flatbed UV inkjet machine, substrate 200 micron gloss PVC printed at 5 pass, 1500 mm/sec, 140% coverage and cured with two lamps set on medium power.

Jetting performance was confirmed on the Spyder 320 flatbed UV inkjet machine under the conditions described above.

The results are shown in the following table:

| | VISCOSITY | | PARTICLE | OPTICAL |
|---|---|---|---|---|
| COLOUR | (mPas) | COLOUR | SIZE (μm) | DENSITY |
| GREEN | 22.9 | L* = 62.54 | 0.40 | 1.93 |
| | | a* = −82.71 | | |
| | | b* = 9.72 | | |
| ORANGE | 21.8 | L* = 66.81 | 0.40 | 1.56 |
| | | a* = 49.41 | | |
| | | b* = 83.20 | | |
| VIOLET | 22.0 | L* = 31.14 | 0.40 | 1.46 |
| | | a* = 62.56 | | |
| | | b* = −66.17 | | |

The colour gamut of the ink-jet ink set of the present invention was compared with the standard CYMK ink jet ink set. The results are shown in FIGS. 1 and 2 which are graphs, plotting a* against b*. FIG. 1 shows the individual colours printed at 100%. FIG. 2 shows a more realistic colour space where combinations of the primary colours have been measured and plotted. It should be noted that using the light magenta does not increase the gamut of achievable colour; rather, its use enhances the visual appearance of prints by enabling a much smoother transition between colours, especially skin-tone colours, and increases the smoothness and visual appearance of the print. The broadening of the gamut in the upper right-hand quadrant in FIG. 2 corresponds to the area skin-tone colours and the broadening of the gamut in the lower right-hand quadrant in FIG. 2 corresponds to a blue often used in corporate colours; both are commercially important areas.

1. An ink jet ink set comprising a plurality of ink jet inks, each ink being substantially free of water and volatile organic solvents, having a viscosity of 100 rnPas or less at 25 T, and comprising at least one radiation-curable monomer, a photoinitiator, and a colorant, wherein the set includes a cyan ink, a magenta ink, a yellow ink, a black ink, and one or more of an orange ink, a green ink and a violet ink.

2. An ink jet ink set as claimed in claim 1, comprising a cyan ink, a magenta ink, a yellow ink, a black ink, and two or more of an orange ink, a green ink and a violet ink.

3. An ink jet ink set as claimed in claim 1, comprising a cyan ink, a magenta ink, a yellow ink, a black ink, an orange ink, a green ink and a violet ink.

4. An ink jet ink set as claimed in claim 1, further comprising one or more of a light cyan ink, a light magenta ink, a light yellow ink a light black ink and a white ink.

5. An ink jet ink set as claimed in claim 4, comprising a cyan ink, a magenta ink, a yellow ink, a black ink, an orange ink, a green ink, a violet ink and a light magenta ink.

6. An ink-jet ink set as claimed in claim 4, comprising a cyan ink, a magenta ink, a yellow ink, a black ink, an orange ink, a violet ink and one or more of a green ink, a light magenta ink and a white ink.

7. An ink-jet ink set as claimed in claim 6, comprising a cyan ink, a magenta ink, a yellow ink, a black ink, an orange ink, a violet ink, light magenta ink and a white ink.

8. An ink jet ink set as claimed in claim 1, where each defined ink has L*, a* and b* value as follows:
cyan: L*=35-69, a*=−60 b*=−70-−20
magenta: L*=30-64, a*=55-105, b*=−40-10
yellow: L*=70-104, a*=−40-10, b*=70-120
black: L*=6-30, a*=−25-25, b*=−20-30
orange: L*=50-90, a*=25-75, b*=55-105
green: L*=40-80, a*=−105-55, b*=−15-35
violet: L*=10-50, a*=35-85, b*=−90-−40
white: L*=81-99, a*=−25-25, b*=−20-30
light cyan: L*=71-105, a=−60-10, b*=−70-−20
light magenta: L*-66−100, a*=55-105, b*=−40-10
light yellow: L*=106-140, a*=−40-10, b*=70-120
light black: L*=35-75, a*=−25-25, b*=−20-30

9. An ink jet ink set as claimed in claim 1, wherein the at least one radiation-curable monomer comprises at least one (meth)acrylate monomer.

10. An ink-jet ink set as claimed in claim 9, wherein the at least one (meth)acrylate monomer is selected from a monofunctional monomer, a multifunctional monomer and combinations thereof.

11. An ink jet ink set as claimed in claim 1, wherein each ink further comprises a polymerisable oligomer.

12. An ink-jet ink set as claimed in claim 11, wherein the polymerisable oligomer has a weight-average molecular weight from 500 to 8,000.

13. An ink-jet ink set as claimed in claim 1, wherein the inks further comprises a least one monofunctional monomer selected from an N-vinyl amide, an N-(meth)acryloyl amine, or a mixture thereof.

14. An ink jet ink set as claimed in claim 1, wherein the colorant is a dispersible pigment.

15. An ink jet ink set as claimed in claim 14, wherein the cyan and light cyan inks contain IRGALITE BLUE GLVO or pigment blue 15:3.

16. An ink jet ink set as claimed in claim 14, wherein the magenta anct light magenta inks contain CINQUASIA MAGENTA RT-355 D or pigment red 202 and/or pigment violet 19.

17. An ink-jet ink set as claimed in claim 14, wherein the yellow and light yellow 5 inks contain NOVOPERM YELLOW H2G, or pigment yellow 120.

18. An ink-jet ink set as claimed in claim 14, wherein the black and light black inks contain SPECIAL BLACK 250, or pigment black 7.

19. An ink-jet ink set as claimed in claim 14, wherein the orange ink contains Kenalake Orange HPRLO, or pigment orange 36.

20. An ink jet ink set as claimed in claim 14, wherein the green ink contains HEUCO GREEN 600703K, or pigment green 7.

21. An ink-jet ink set as claimed in claim 14, wherein the violet ink contains Hostaperm Violet RL-NF, or pigment violet 23.

22. An ink-jet ink set as claimed in claim 14, wherein the white ink contains pigment white 6.

23. A method of ink-jet printing, comprising printing the inks from the ink jet ink set as claimed in claim 1 on to a substrate and curing the inks.

24. A substrate having the inks from the ink jet ink set as claimed in claim 1 printed thereon.

25. A set of ink jet ink cartridges wherein each cartridge contains one of the inks from the set as claimed in claim 1.
